(19) United States
(12) Patent Application Publication
(10) Pub. No.: US 2020/0290412 A1
(43) Pub. Date: Sep. 17, 2020

(54) CONTAINER HITCH FOR FACILITATING DETACHABLY ATTACHING OF A CONTAINER TO A VEHICLE

(71) Applicant: John Harold Robinson, Fairland, OK (US)

(72) Inventor: John Harold Robinson, Fairland, OK (US)

(21) Appl. No.: 16/816,632

(22) Filed: Mar. 12, 2020

Related U.S. Application Data
(63) Continuation-in-part of application No. 29/723,671, filed on Feb. 10, 2020.
(60) Provisional application No. 62/818,191, filed on Mar. 14, 2019.

(51) Int. Cl. B60D 1/04; B60D 1/36

(52) U.S. Cl. CPC B60D 1/04; B60D 1/06; B60D 1/36

(57) ABSTRACT

Disclosed herein is a container hitch for facilitating detachably attaching of a container to a vehicle. Accordingly, the container hitch may include a primary member (PM), a secondary member (SM), and a tertiary member (TM). Further, the PM may be detachably couplable to a tow hitch of a vehicle using a primary coupling mechanism. Further, a first primary part of the primary coupling mechanism may be included in a first primary end of the PM and a second primary part of the primary coupling mechanism may be included in the tow hitch. Further, the SM may be coupled to the PM. Further, a first secondary end of the SM may be coupled to a second primary end of the PM. Further, the TM may be coupled with the SM. Further, a first tertiary end of the TM may be coupled with a second secondary end of the SM.

The current application claims a priority to the U.S. Provisional Patent application Ser. No. 62/818,191 filed on Mar. 14, 2019.

### FIELD OF THE INVENTION

Generally, the present disclosure relates to the field of hitches. More specifically, the present disclosure relates to a container hitch for facilitating detachably attaching of a container to a vehicle.

### BACKGROUND OF THE INVENTION

Hitches may be used for pulling and transporting containers such as wheeled refuse, trash can, garbage can, cart, and receptacle. Further, the hitches may be used for hauling the containers to the designated area for pick up by the waste management company. Many people are not physically able to do weekly tasks of walking and pulling the cart to its pickup destination, and climate changes can hinder or add to the hardship to the weekly tasks.

Therefore, there is a need for an improved container hitch for facilitating detachably attaching of a container to a vehicle that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a container hitch for facilitating detachably attaching of a container to a vehicle, in accordance with some embodiments. Accordingly, the container hitch may include a primary member, a secondary member, and a tertiary member. Further, the primary member may be detachably couplable to a tow hitch of a vehicle using a primary coupling mechanism. Further, a first primary part of the primary coupling mechanism may be included in a first primary end of the primary member and a second primary part of the primary coupling mechanism may be included in the tow hitch. Further, the first primary part and the second primary part may be detachably couplable. Further, the first primary part may include a plurality of primary hooks separated by a primary distance. Further, the second primary part may include a tow ball of the tow hitch. Further, the tow ball may be characterized by a tow ball diameter. Further, the plurality of primary hooks may be configured for removably receiving the tow ball. Further, the secondary member may be coupled to the primary member. Further, a first secondary end of the secondary member may be coupled to a second primary end of the primary member. Further, a primary longitudinal axis of the primary member forms a first angle with a secondary longitudinal axis of the secondary member. Further, the tertiary member may be coupled with the secondary member. Further, a first tertiary end of the tertiary member may be coupled with a second secondary end of the secondary member. Further, the secondary longitudinal axis forms a second angle with a tertiary longitudinal axis of the tertiary member. Further, the tertiary member may be detachably couplable with a container using a tertiary coupling mechanism. Further, a first tertiary part of the tertiary coupling mechanism may be included in a second tertiary end of the tertiary member and a second tertiary part of the tertiary coupling mechanism may be included in the container. Further, the first tertiary part may be detachably couplable to the second tertiary part. Further, the first tertiary part may include a plurality of tertiary hooks separated by a tertiary distance. Further, the second tertiary part may include a handle of the container. Further, the plurality of tertiary hooks may be configured for removably receiving the handle.

Further disclosed herein is a container hitch for facilitating detachably attaching of a container to a vehicle, in accordance with some embodiments. Accordingly, the container hitch may include a primary member, a secondary member, and a tertiary member. Further, the primary member may be detachably couplable to a tow hitch of a vehicle using a primary coupling mechanism. Further, a first primary part of the primary coupling mechanism may be included in a first primary end of the primary member and a second primary part of the primary coupling mechanism may be included in the tow hitch. Further, the first primary part and the second primary part may be detachably couplable. Further, the first primary part may include at least two primary hooks separated by a primary distance. Further, the second primary part may include a tow ball of the tow hitch. Further, the tow ball may be characterized by a tow ball diameter. Further, a first primary hook may be separated from a second primary hook by the primary distance for forming a primary hook aperture. Further, the primary hook aperture may be characterized by a hook aperture diameter. Further, the hook aperture diameter may be less than the tow ball diameter. Further, the at least two primary hooks encompasses the tow ball in at least one part for detachably coupling of the at least two hooks with the tow ball. Further, the secondary member may be coupled to the primary member. Further, a first secondary end of the secondary member may be coupled to a second primary end of the primary member. Further, a primary longitudinal axis of the primary member forms a first angle with a secondary longitudinal axis of the secondary member. Further, the tertiary member may be coupled with the secondary member. Further, a first tertiary end of the tertiary member may be coupled with a second secondary end of the secondary member. Further, the secondary longitudinal axis forms a second angle with a tertiary longitudinal axis of the tertiary member. Further, the tertiary member may be detachably couplable with a container using a tertiary coupling mechanism. Further, a first tertiary part of the tertiary coupling mechanism may be included in a second tertiary end of the tertiary member and a second tertiary part of the tertiary coupling mechanism may be included in the container. Further, the first tertiary part may be detachably couplable to the second tertiary part. Further, the first tertiary part may include a hook member and at least two horn-shaped hooks separated by a tertiary distance. Further, the second tertiary part may include a handle of the container. Further, the hook member may be characterized by a hook member length. Further, a first horn-shaped hook and a second horn-shaped hook are parallelly attached to the hook member along the hook member length separated by the tertiary distance. Further, the at least two horn-shaped hooks may be configured for removably receiving the handle.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a side perspective view of a container hitch for facilitating detachably attaching of a container to a vehicle, in accordance with some embodiments.

FIG. 2 is a top perspective view of the container hitch for facilitating detachably attaching of the container to the vehicle, in accordance with some embodiments.

FIG. 3 is a front perspective view of the container hitch for facilitating detachably attaching of the container to the vehicle, in accordance with some embodiments.

FIG. 4 is an exploded view of the container hitch for facilitating detachably attaching of the container to the vehicle, in accordance with some embodiments.

FIG. 5 is a front perspective view of the container hitch for facilitating detachably attaching of the container to the vehicle, in accordance with some embodiments.

FIG. 6 is a side perspective view of a container hitch for facilitating detachably attaching of a container to a vehicle, in accordance with some embodiments.

FIG. 7 is a top perspective view of the container hitch for facilitating detachably attaching of the container to the vehicle, in accordance with some embodiments.

FIG. 8 is a front perspective view of the container hitch for facilitating detachably attaching of the container to the vehicle, in accordance with some embodiments.

FIG. 9 is an exploded view of the container hitch for facilitating detachably attaching of the container to the vehicle, in accordance with some embodiments.

FIG. 10 is a front perspective view of the container hitch for facilitating detachably attaching of the container to the vehicle, in accordance with some embodiments.

FIG. 11 is a front perspective view of a container hitch for facilitating detachably attaching of a container to a vehicle, in accordance with some embodiments.

FIG. 12 is a side view of a container hitch without a hook member, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a container hitch for facilitating detachably attaching of a container to a vehicle, embodiments of the present disclosure are not limited to use only in this context.

### Overview

The present disclosure describes a container hitch for facilitating detachably attaching of a container to a vehicle. Further, the present disclosure may take away or remove the physical stress and labor of walking and pulling a wheeled trash receptacle or a waste cart down a long driveway.

Further, the container hitch may be called as “The Bighorn Trash Hitch”. Further, “The Bighorn Trash Hitch” may be a unique apparatus designed specifically to be easily hooked up to any motorized vehicle ball and receiver hitch to transport a refuse cart with wheels and pull it to the designated location, for local waste management company to pick it up or lift it upside down to empty the refuse cart. Then the owner can return the refuse cart back to its desired location.

Further, “The Bighorn Trash Hitch” may be designed with a hook shape on one end that may have a specially measured aperture to place over the majority of either a 1⅞″ ball or 2″ ball, up to a 2 5/16″ ball and a receiver hitch on any motorized vehicle, then the hook may be flipped over to secure it right side up. At the other end of “The Bighorn Trash Hitch” may include two metal hornlike shaped hooks that are 9″ apart so the handle of the waste cart may be tilted over and fit snuggly into its two hooks; it is also designed to swivel when turning the vehicle, it is hitched to.

Even though 95% of driveways may not require these, there are two holes drilled into the horn end of the hitch where hitch pin clips may be placed when securing “The Bighorn Trash Hitch” to the refuse cart that may act as an additional safety feature in cases where there are bumpy or uneven driveways. Also added feature is one side of each hook may be designed a little longer to hold the refuse cart lid in place so that it may not come open during transport.

Although “The Bighorn Trash Hitch” is manufactured from ⅜″ round steel it is compact and light enough for any person to handle.

Further, the vehicle towing the trash receptacle should never be driven faster than the speed in which a person who pulls the trash cart/receptacle by hand would go. The wheels on these trash receptacles are not designated for fast speeds.

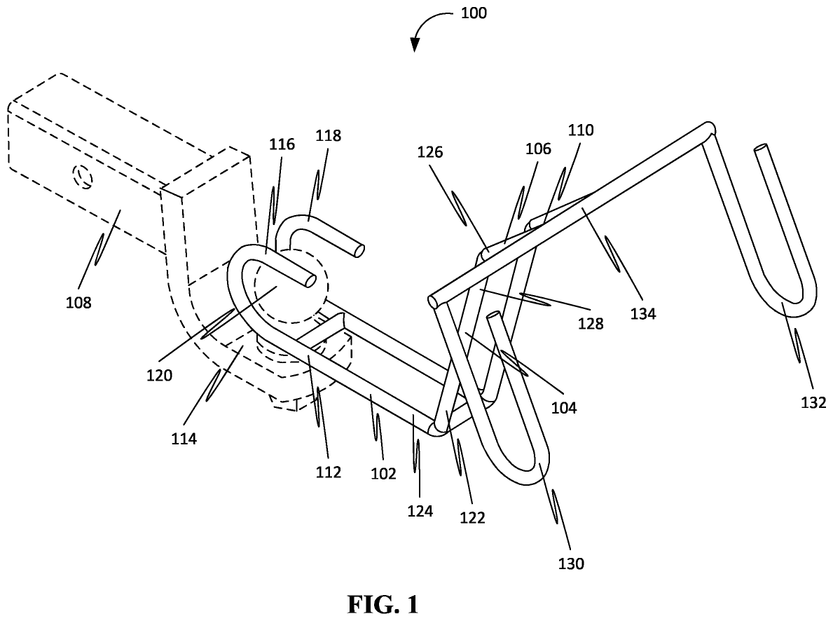

FIG. 1 is a side perspective view of a container hitch 100 for facilitating detachably attaching of a container to a vehicle, in accordance with some embodiments. Accordingly, the container hitch 100 may include a primary member 102, a secondary member 104, and a tertiary member 106.

Further, the primary member 102 may be detachably couplable to a tow hitch 108 of a vehicle using a primary coupling mechanism. Further, a first primary part of the primary coupling mechanism may be included in a first primary end 112 of the primary member 102 and a second primary part 114 of the primary coupling mechanism may be included in the tow hitch 108. Further, the first primary part may include a plurality of primary hooks 116-118 separated by a primary distance. Further, the first primary part and the second primary part 114 may be detachably couplable. Further, the second primary part 114 may include a tow ball 120 of the tow hitch 108. Further, the tow ball 120 may be characterized by a tow ball diameter. Further, the plurality of primary hooks 116-118 may be configured for removably receiving the tow ball 120.

Further, the secondary member 104 may be coupled to the primary member 102. Further, a first secondary end 122 of the secondary member 104 may be coupled to a second primary end 124 of the primary member 102. Further, a primary longitudinal axis of the primary member 102 forms a first angle with a secondary longitudinal axis of the secondary member 104.

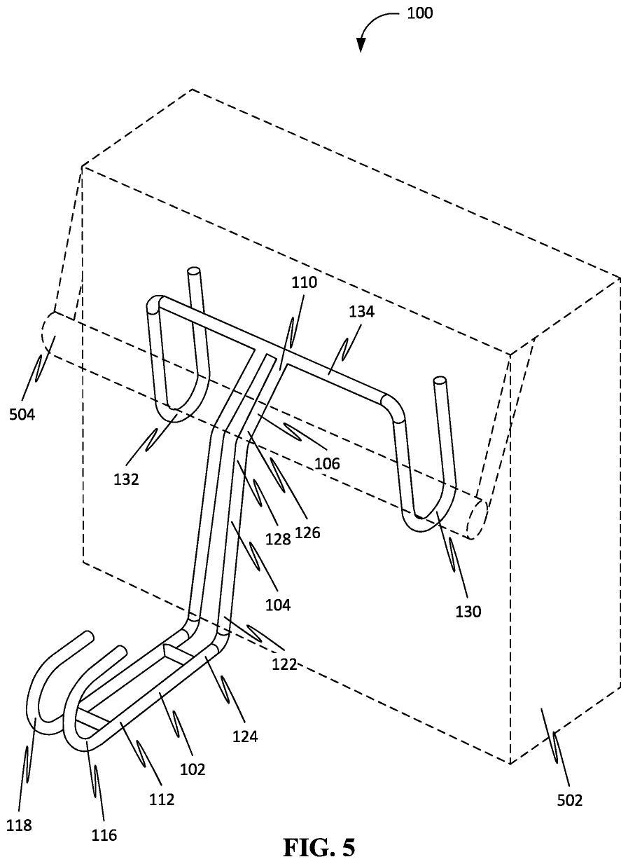

Further, the tertiary member 106 may be coupled with the secondary member 104. Further, a first tertiary end 126 of the tertiary member 106 may be coupled with a second secondary end 128 of the secondary member 104. Further, the secondary longitudinal axis forms a second angle with a tertiary longitudinal axis of the tertiary member 106. Further, the tertiary member 106 may be detachably couplable with a container 502, as shown in FIG. 5, using a tertiary coupling mechanism. Further, a first tertiary part of the tertiary coupling mechanism may be included in a second tertiary end 110 of the tertiary member 106 and a second tertiary part of the tertiary coupling mechanism may be included in the container 502. Further, the first tertiary part may include a plurality of tertiary hooks 130-132 separated by a tertiary distance. Further, the first tertiary part may be detachably couplable to the second tertiary part. Further, the second tertiary part may include a handle 504 of the container 502, as shown in FIG. 5. Further, the plurality of tertiary hooks 130-132 may be configured for removably receiving the handle 504.

Further, in some embodiments, the plurality of primary hooks 116-118 may include at least two hooks. Further, a first hook 116 may be separated from a second hook 118 by the primary distance forming a hook aperture. Further, the hook aperture may be characterized by a hook aperture diameter. Further, the hook aperture diameter may be less than the tow ball diameter. Further, the at least two hooks encompasses the tow ball 120 in at least one part for detachably coupling of the at least two hooks with the tow ball 120.

Further, in some embodiments, the plurality of tertiary hooks 130-132 may include a hook member 134 and at least two horn-shaped hooks. Further, the hook member 134 may be characterized by a hook member length. Further, a first horn-shaped hook and a second horn-shaped hook are parallelly attached to the hook member 134 and separated by the tertiary distance along the hook member length.

Further, in some embodiments, the first angle may be an obtuse angle.

Further, in some embodiments, the secondary member 104 may be movably coupled with the primary member 102 for providing a relative movement to the secondary member 104 in relation to the primary member 102. Further, in some embodiments, the secondary member 104 may be configured resistively move between a plurality of secondary member positions in relation to the primary member 102.

Further, in some embodiments, the second angle may be an obtuse angle.

Further, in some embodiments, the tertiary member 106 may be movably coupled with the secondary member 104 for providing a relative movement to the tertiary member 106 in relation to the secondary member 104. Further, in some embodiments, the tertiary member 106 may be configured to resistively move between a plurality of tertiary member positions in relation to the secondary member 104.

In further embodiments, a securing mechanism (not shown) may be included in the plurality of tertiary hooks 130-132. Further, the securing mechanism may include a securing member Further, the securing member attaches to at least two hook portions of a tertiary hook forming a hook enclosure for encompassing the handle 504. Further, the encompassing secures the handle 504 to the tertiary hook.

In further embodiments, a spring (not shown) may be coupled to the tertiary member 106 and the secondary member 104. Further, the spring may be configured for resisting a vertical relative motion between the container 502 and a surface. Further, the spring may be configured for translating the relative motion in an oscillation of the spring. In further embodiments, a dampener (not shown) may be coupled to the tertiary member 106 and the secondary member 104. Further, the damper may be configured for damping the oscillation of the spring.

In further embodiments, a safety mechanism may be included in the plurality of tertiary hooks 130-132. Further, the safety mechanism may include at least one safety member attached to a first hook end (not shown) of a tertiary hook (not shown). Further, the at least one safety member may be configured for securing a container lid of the container 502 in at least one lid position.

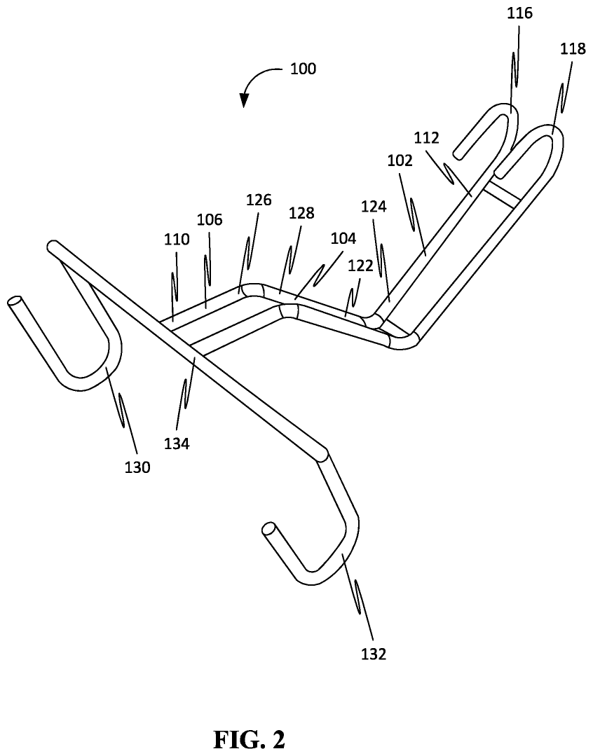

FIG. 2 is a top perspective view of the container hitch 100 for facilitating detachably attaching of the container to the vehicle, in accordance with some embodiments.

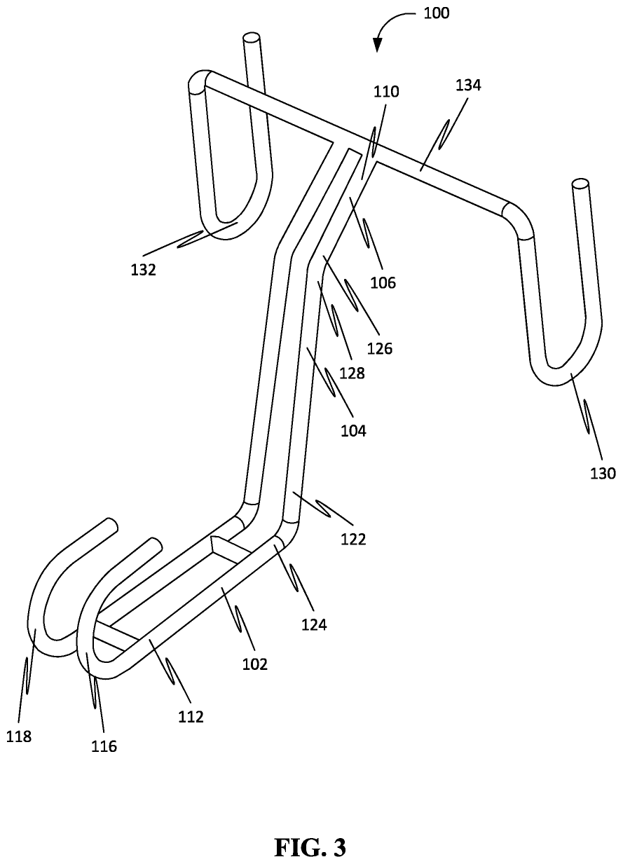

FIG. 3 is a front perspective view of the container hitch 100 for facilitating detachably attaching of the container to the vehicle, in accordance with some embodiments.

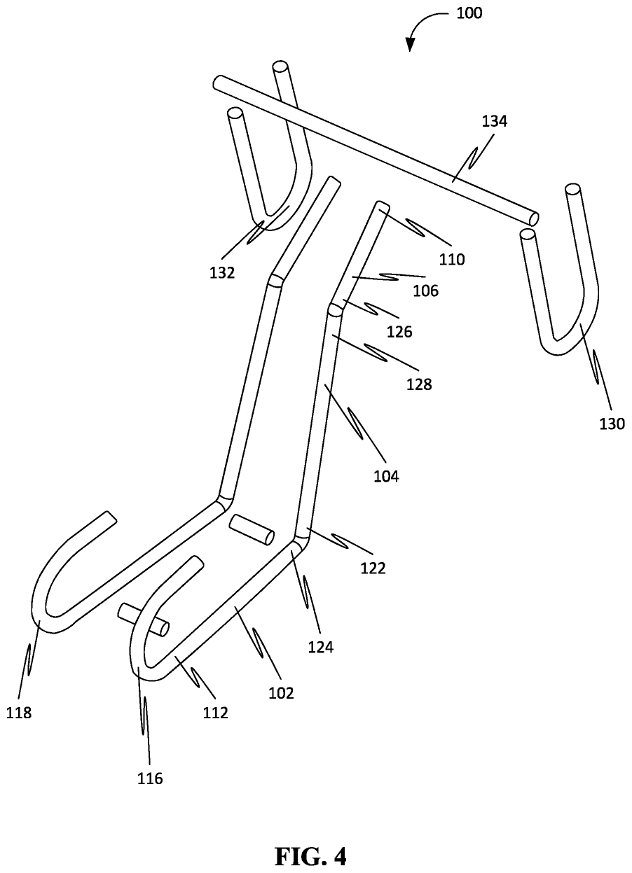

FIG. 4 is an exploded view of the container hitch 100 for facilitating detachably attaching of the container to the vehicle, in accordance with some embodiments.

FIG. 5 is a front perspective view of the container hitch 100 for facilitating detachably attaching of the container to the vehicle, in accordance with some embodiments.

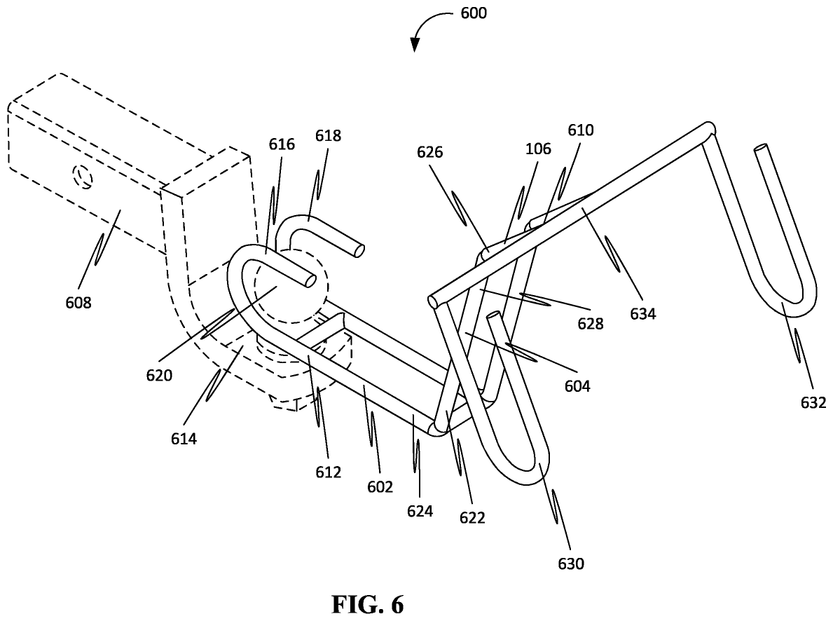

FIG. 6 is a side perspective view of a container hitch 600 for facilitating detachably attaching of a container to a vehicle, in accordance with some embodiments . Accordingly, the container hitch 600 may include a primary member 602, a secondary member 604, and a tertiary member 606.

Further, the primary member 602 may be detachably couplable to a tow hitch 608 of a vehicle using a primary coupling mechanism. Further, a first primary part (not shown) of the primary coupling mechanism may be included in a first primary end 612 of the primary member 602 and a second primary part 614 of the primary coupling mechanism may be included in the tow hitch 608. Further, the first primary part and the second primary part 614 may be detachably couplable. Further, the first primary part may include at least two primary hooks 616-618 separated by a primary distance. Further, the second primary part 614 may include a tow ball 620 of the tow hitch 608. Further, the tow ball 620 may be characterized by a tow ball diameter. Further, a first primary hook 616 may be separated from a second primary hook 618 by the primary distance for forming a primary hook aperture. Further, the primary hook aperture may be characterized by a hook aperture diameter. Further, the hook aperture diameter may be less than the tow ball diameter. Further, the at least two primary hooks 616-618 encompasses the tow ball 620 in at least one part for detachably coupling of the at least two hooks with the tow ball 620.

Further, the secondary member 604 may be coupled to the primary member 602. Further, a first secondary end 622 of the secondary member 604 may be coupled to a second primary end 624 of the primary member 602. Further, a primary longitudinal axis of the primary member 602 forms a first angle with a secondary longitudinal axis of the secondary member 604.

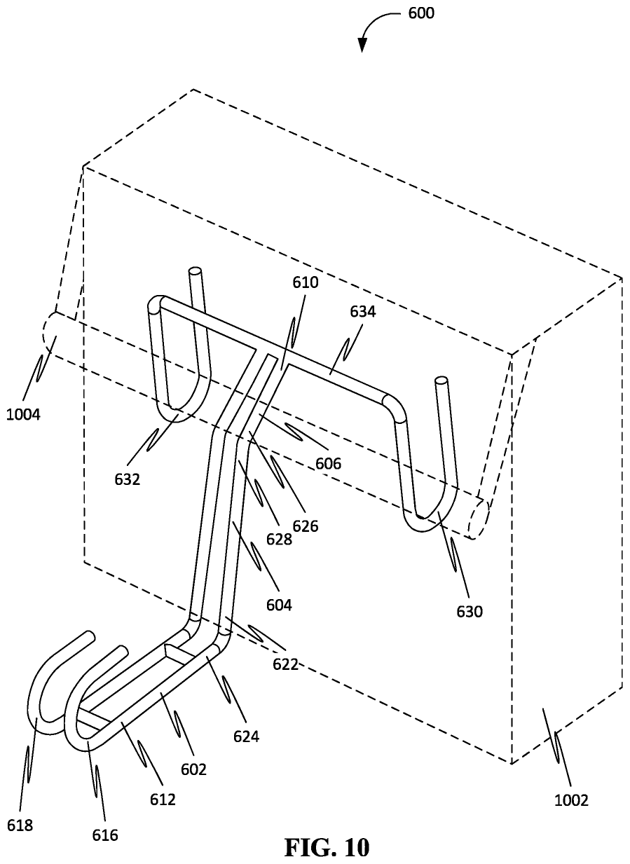

Further, the tertiary member 606 may be coupled with the secondary member 604. Further, a first tertiary end 626 of the tertiary member 606 may be coupled with a second secondary end 6128 of the secondary member 604. Further, the secondary longitudinal axis forms a second angle with a tertiary longitudinal axis of the tertiary member 606. Further, the tertiary member 606 may be detachably couplable with a container 1002, as shown in FIG. 10, using a tertiary coupling mechanism. Further, a first tertiary part of the tertiary coupling mechanism may be included in a second tertiary end 610 of the tertiary member 606 and a second tertiary part of the tertiary coupling mechanism may be included in the container 1002. Further, the first tertiary part may be detachably couplable to the second tertiary part. Further, the first tertiary part may include a hook member 634 and at least two horn-shaped hooks 630-632 separated by a tertiary distance. Further, the second tertiary part may include a handle 1004 of the container 1002, as shown in FIG. 10. Further, the hook member 634 may be characterized by a hook member length. Further, a first horn-shaped hook 630 and a second horn-shaped hook 632 are parallelly attached to the hook member 634 along the hook member length separated by the tertiary distance. Further, the at least two horn-shaped hooks 630-632 may be configured for removably receiving the handle 1004.

Further, in some embodiments, the first angle may be an obtuse angle.

Further, in some embodiments, the secondary member 604 may be movably coupled with the primary member 602 for providing a relative movement to the secondary member 604 in relation to the primary member 602.

Further, in some embodiments, the second angle may be an obtuse angle.

Further, in some embodiments, the tertiary member 606 may be movably coupled with the secondary member 604 for providing a relative movement to the tertiary member 606 in relation to the secondary member 604.

In further embodiments, a securing mechanism may be included in the at least two horn-shaped hooks 630-632. Further, the securing mechanism may include a securing member (not shown). Further, the securing member attaches to at least two hook portions of a horn-shaped hook forming a hook enclosure for encompassing the handle 1004. Further, the encompassing secures the handle 1004 to the horn-shaped hook. In further embodiments, a safety mechanism included in the at least two horn-shaped hooks 630-632. Further, the safety mechanism may include at least one safety member attached to a first hook end of a horn-shaped hook. Further, the at least one safety member may be configured for securing a container lid of the container 1002 in at least one lid position.

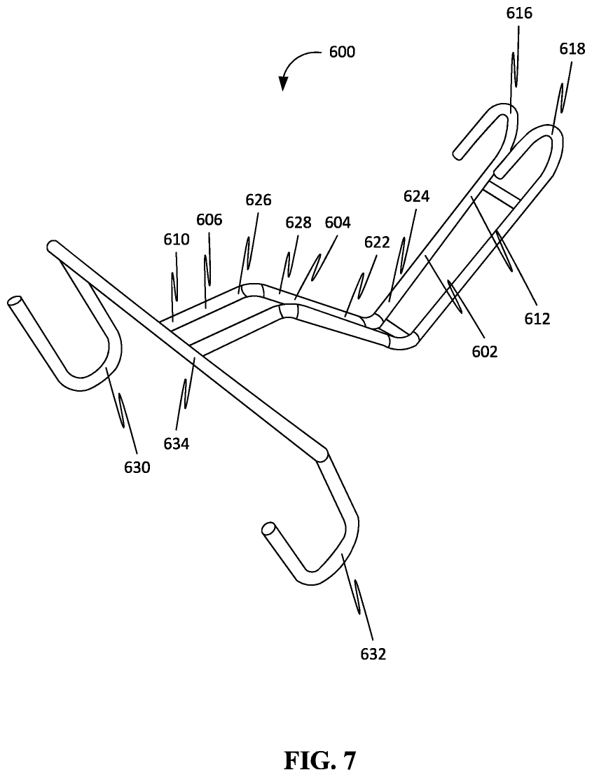

FIG. 7 is a top perspective view of the container hitch 600 for facilitating detachably attaching of the container to the vehicle, in accordance with some embodiments.

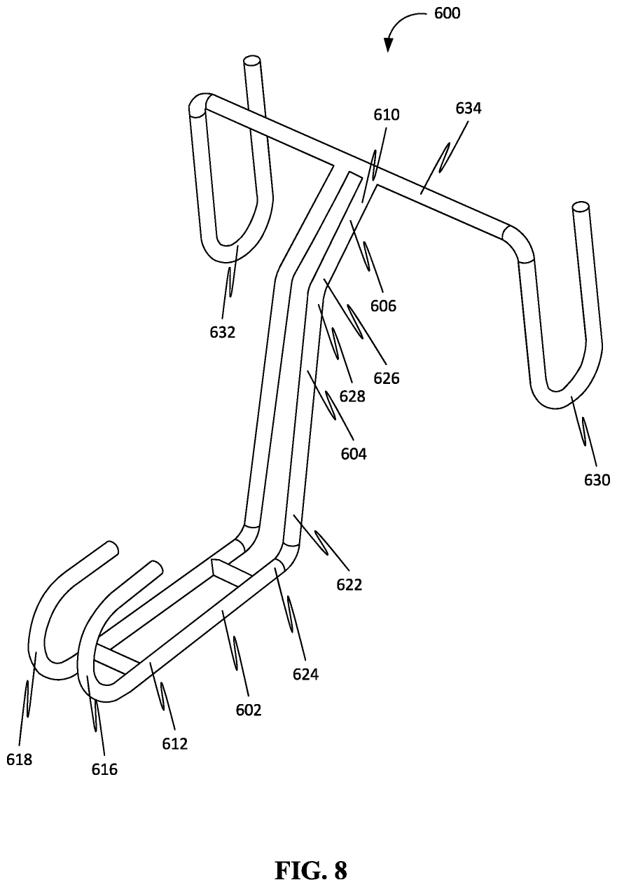

FIG. 8 is a front perspective view of the container hitch 600 for facilitating detachably attaching of the container to the vehicle, in accordance with some embodiments.

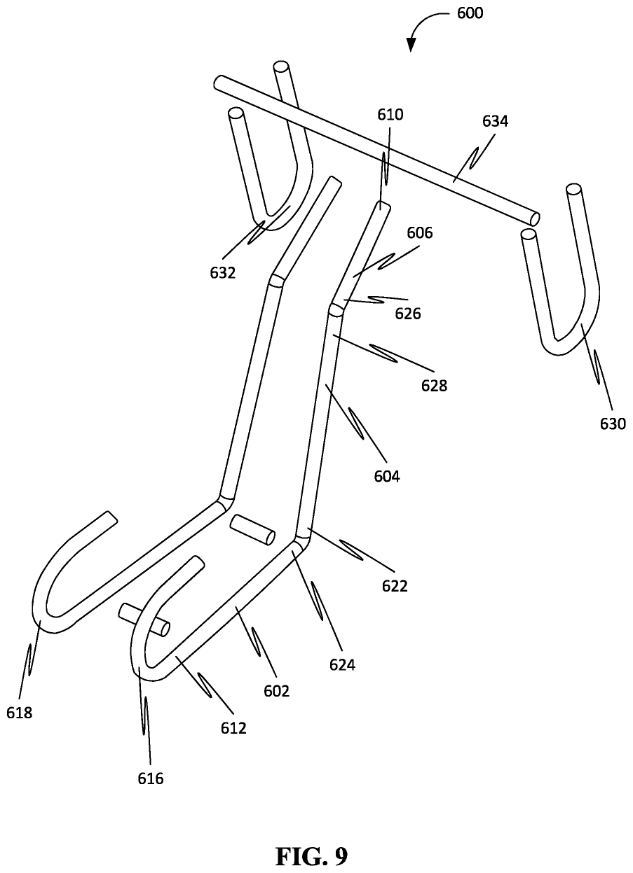

FIG. 9 is an exploded view of the container hitch 600 for facilitating detachably attaching of the container to the vehicle, in accordance with some embodiments.

FIG. 10 is a front perspective view of the container hitch 600 for facilitating detachably attaching of the container to the vehicle, in accordance with some embodiments.

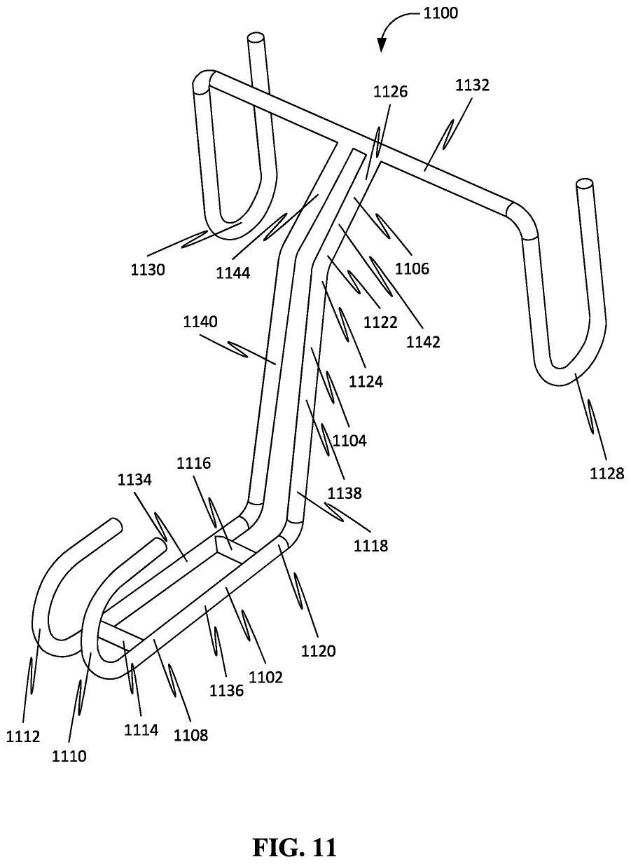

FIG. 11 is a front perspective view of a container hitch 1100 for facilitating detachably attaching of a container to a vehicle, in accordance with some embodiments. Accordingly, the container hitch 1100 may include a primary member 1102, a secondary member 1104, and a tertiary member 1106.

Further, the primary member 1102 may be detachably couplable to a tow hitch of a vehicle using a primary coupling mechanism. Further, a first primary part of the primary coupling mechanism may be included in a first primary end 1108 of the primary member 1102 and a second primary part of the primary coupling mechanism may be included in the tow hitch. Further, the first primary part and the second primary part may be detachably couplable. Further, the first primary part may include a plurality of primary hooks 1110-1112 separated by a primary distance. Further, the primary member 1102 may be a 0.375 ROD having 3X bends. Further, the primary member 1102 may include a plurality of long rods and a plurality of short rods. Further, the plurality of long rods may include a first long rod 1136 and a second long rod 1138. Further, the plurality of short rods may include a first short rod 1116 and a second short rod 1114. Further, the first long rod 1136 may be parallelly positioned along the second long rod 1138 separated by a primary distance. Further, the first short rod 1116 is attached to a first end of each of the first long rod 1136 and the second long rod 1138. Further, the second short rod 1114 may be attached to a second end of each of the first long rod 1136 and the second long rod 1138. Further, the first short rod 1116 may be a 0.375 ROD X 1.351g. Further, the second short rod 1114 be a 0.375 ROD X 1.151g.

Further, the secondary member 1104 may be coupled to the primary member 1102. Further, the secondary member 1104 may include a plurality of long rods. Further, the plurality of long rods may include a first long rod 1138 and a second long rod 1140. Further, the secondary member 1104 may be a 0.375 ROD having 3X bends. Further, a first secondary end 1118 of the secondary member 1104 may be coupled to a second primary end 1120 of the primary member 1102. Further, a primary longitudinal axis of the primary member 1102 forms a first angle with a secondary longitudinal axis of the secondary member 1104. Further, the first angle may be 105°.

Further, the tertiary member 1106 may be coupled with the secondary member 1104. Further, the tertiary member 1106 may include a plurality of long rods. Further, the plurality of long rods may include a first long rod 1142 and a second long rod 1144. Further, the tertiary member 1106 may be a 0.375 ROD having 3X bends. Further, a first tertiary end 1122 of the tertiary member 1106 may be coupled with a second secondary end 1124 of the secondary member 1104. Further, the secondary longitudinal axis forms a second angle with a tertiary longitudinal axis of the tertiary member 1106. Further, the second angle may be 145°. Further, the tertiary member 1106 may be detachably couplable with a container using a tertiary coupling mechanism. Further, a first tertiary part of the tertiary coupling mechanism may be included in a second tertiary end 1126 of the tertiary member 1106 and a second tertiary part of the tertiary coupling mechanism may be included in the container. Further, the first tertiary part may include a plurality of tertiary hooks 1128-1130 separated by a tertiary distance. Further, the plurality of tertiary hooks 1128-1130 may include a hook member 1132. Further, the hook member 1132 may be characterized by a hook member length. Further, the hook member may be a 0.375 ROD having 4X bends. Further, a first hook 1128 and a second hook 1130 may be parallelly attached to the hook member 1132 and separated by the tertiary distance along the hook member length.

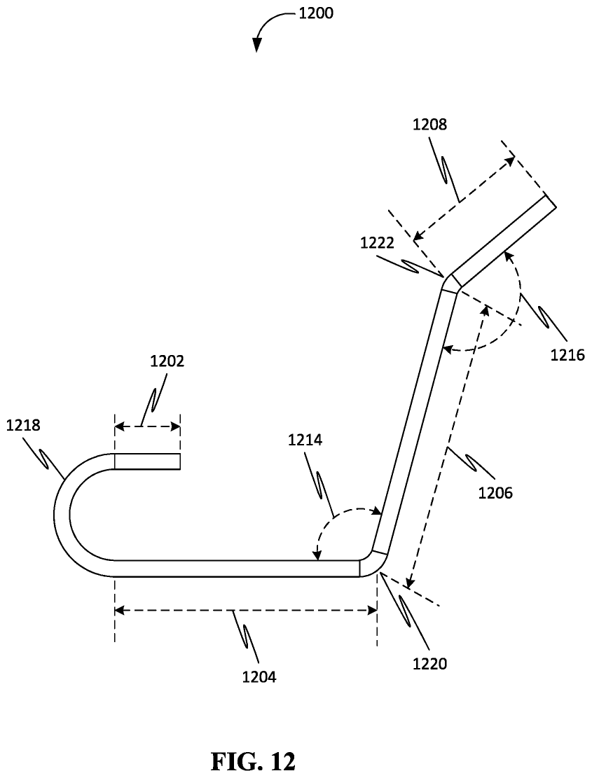

FIG. 12 is a side view of a container hitch 1200 without a hook member, in accordance with some embodiments. Further, a length 1202 may be 1.50 inches. Further, a radius 1218 may be R1.23 inches. Further, a length 1204 may be 6 inches. Further, a radius 1220 may be R.5 inches. Further, a length 1206 may be 6.75 inches. Further, an angle 1214 may be 105°. Further, a length 1208 may be 3 inches. Further, an angle 1216 may be 145°. Further, a radius 1222 may be R.5 inches. Further, the container hitch 1200 may be associated with an angular tolerance of MACH±30′. Further, the container hitch 1200 may include edges with a radius ranging from 0.020″-0.030″. Further, the container hitch 1200 may be associated with a T.I.R (total indicator reading) of 0.005″ Max. Further, the container hitch 1200 may be associated with a max finish of 125[3.2]. Further, the container hitch 1200 may be associated with AISI 1018 carbon steel material. Further, tolerance up to two decimal place may be ±0.010. Further, tolerance up to three decimal place may be ±0.005.

Although the present disclosure has been explained in relation to its preferred embodiment, it is to be understood that many other possible modifications and variations can be made without departing from the spirit and scope of the disclosure.

What is claimed is:

1. A container hitch for facilitating detachably attaching of a container to a vehicle, the container hitch comprising:
a primary member detachably couplable to a tow hitch of a vehicle using a primary coupling mechanism, wherein a first primary part of the primary coupling mechanism is comprised in a first primary end of the primary member and a second primary part of the primary coupling mechanism is comprised in the tow hitch, wherein the first primary part and the second primary part is detachably couplable, wherein the first primary part comprises a plurality of primary hooks separated by a primary distance, wherein the second primary part comprises a tow ball of the tow hitch, wherein the tow ball is characterized by a tow ball diameter, wherein the plurality of primary hooks is configured for removably receiving the tow ball;
a secondary member coupled to the primary member, wherein a first secondary end of the secondary member is coupled to a second primary end of the primary member, wherein a primary longitudinal axis of the primary member forms a first angle with a secondary longitudinal axis of the secondary member; and
a tertiary member coupled with the secondary member, wherein a first tertiary end of the tertiary member is coupled with a second secondary end of the secondary member, wherein the secondary longitudinal axis forms a second angle with a tertiary longitudinal axis of the tertiary member, wherein the tertiary member is detachably couplable with a container using a tertiary coupling mechanism, wherein a first tertiary part of the tertiary coupling mechanism is comprised in a second tertiary end of the tertiary member and a second tertiary part of the tertiary coupling mechanism is comprised in the container, wherein the first tertiary part is detachably couplable to the second tertiary part, wherein the first tertiary part comprises a plurality of tertiary hooks separated by a tertiary distance, wherein the second tertiary part comprises a handle of the container, wherein the plurality of tertiary hooks is configured for removably receiving the handle.

2. The container hitch of claim 1, wherein the plurality of primary hooks comprises at least two hooks, wherein a first hook is separated from a second hook by the primary distance forming a hook aperture, wherein the hook aperture is characterized by a hook aperture diameter, wherein the hook aperture diameter is less than the tow ball diameter, wherein the at least two hooks encompasses the tow ball in at least one part for detachably coupling of the at least two hooks with the tow ball.

3. The container hitch of claim 1, wherein the plurality of tertiary hooks comprises a hook member and at least two horn-shaped hooks, wherein the hook member is characterized by a hook member length, wherein a first horn-shaped hook and a second horn-shaped hook are parallelly attached to the hook member and separated by the tertiary distance along the hook member length.

4. The container hitch of claim 1, wherein the first angle is an obtuse angle.

5. The container hitch of claim 1, wherein the secondary member is movably coupled with the primary member for providing a relative movement to the secondary member in relation to the primary member.

6. The container hitch of claim 5, wherein the secondary member is configured resistively move between a plurality of secondary member positions in relation to the primary member.

7. The container hitch of claim 1, wherein the second angle is an obtuse angle.

8. The container hitch of claim 1, wherein the tertiary member is movably coupled with the secondary member for providing a relative movement to the tertiary member in relation to the secondary member.

9. The container hitch of claim 8, wherein the tertiary member is configured resistively move between a plurality of tertiary member positions in relation to the secondary member.

10. The container hitch of claim 1 further comprising a securing mechanism comprised in the plurality of tertiary hooks, wherein the securing mechanism comprises a securing member, wherein the securing member attaches to at least two hook portions of a tertiary hook forming a hook enclosure for encompassing the handle, wherein the encompassing secures the handle to the tertiary hook.

11. The container hitch of claim 1 further comprising a spring coupled to the tertiary member and the secondary member, wherein the spring is configured for resisting a vertical relative motion between the container and a surface, wherein the spring is configured for translating the relative motion in an oscillation of the spring.

12. The container hitch of claim 11 further comprising a dampener coupled to the tertiary member and the secondary member, wherein the damper is configured for damping the oscillation of the spring.

13. The container hitch of claim 1 further comprises a safety mechanism comprised in the plurality of tertiary hooks, wherein the safety mechanism comprises at least one safety member attached to a first hook end of a tertiary hook, wherein the at least one safety member is configured for securing a container lid of the container in at least one lid position.

14. A container hitch for facilitating detachably attaching of a container to a vehicle, the container hitch comprising:
a primary member detachably couplable to a tow hitch of a vehicle using a primary coupling mechanism, wherein a first primary part of the primary coupling mechanism is comprised in a first primary end of the primary member and a second primary part of the primary coupling mechanism is comprised in the tow hitch, wherein the first primary part and the second primary part is detachably couplable, wherein the first primary part comprises at least two primary hooks separated by a primary distance, wherein the second primary part comprises a tow ball of the tow hitch, wherein the tow ball is characterized by a tow ball diameter, wherein a first primary hook is separated from a second primary hook by the primary distance for forming a primary hook aperture, wherein the primary hook aperture is characterized by a hook aperture diameter, wherein the hook aperture diameter is less than the tow ball diameter, wherein the at least two primary hooks encompasses the tow ball in at least one part for detachably coupling of the at least two hooks with the tow ball;
a secondary member coupled to the primary member, wherein a first secondary end of the secondary member is coupled to a second primary end of the primary member, wherein a primary longitudinal axis of the primary member forms a first angle with a secondary longitudinal axis of the secondary member; and
a tertiary member coupled with the secondary member, wherein a first tertiary end of the tertiary member is coupled with a second secondary end of the secondary member, wherein the secondary longitudinal axis forms a second angle with a tertiary longitudinal axis of the tertiary member, wherein the tertiary member is detachably couplable with a container using a tertiary coupling mechanism, wherein a first tertiary part of the tertiary coupling mechanism is comprised in a second tertiary end of the tertiary member and a second tertiary part of the tertiary coupling mechanism is comprised in the container, wherein the first tertiary part is detachably couplable to the second tertiary part, wherein the first tertiary part comprises a hook member and at least two horn-shaped hooks separated by a tertiary distance, wherein the second tertiary part comprises a handle of the container, wherein the hook member is characterized by a hook member length, wherein a first horn-shaped hook and a second horn-shaped hook are parallelly attached to the hook member along the hook member length separated by the tertiary distance, wherein the at least two horn-shaped hooks is configured for removably receiving the handle.

15. The container hitch of claim 14, wherein the first angle is an obtuse angle.

16. The container hitch of claim 14, wherein the secondary member is movably coupled with the primary member for providing a relative movement to the secondary member in relation to the primary member.

17. The container hitch of claim 14, wherein the second angle is an obtuse angle.

18. The container hitch of claim 14, wherein the tertiary member is movably coupled with the secondary member for providing a relative movement to the tertiary member in relation to the secondary member.

19. The container hitch of claim 14 further comprising a securing mechanism comprised in the at least two horn-shaped hooks, wherein the securing mechanism comprises a securing member, wherein the securing member attaches to at least two hook portions of a horn-shaped hook forming a hook enclosure for encompassing the handle, wherein the encompassing secures the handle to the horn-shaped hook.

20. The container hitch of claim 14 further comprises a safety mechanism comprised in the at least two horn-shaped hooks, wherein the safety mechanism comprises at least one safety member attached to a first hook end of a horn-shaped hook, wherein the at least one safety member is configured for securing a container lid of the container in at least one lid position.
